(19) United States
(12) Patent Application Publication
(10) Pub. No.: US 2021/0322244 A1
(43) Pub. Date: Oct. 21, 2021

(54) INFLATABLE ISOLATION SYSTEM AND METHOD OF USE

(71) Applicant: Prep Tech, L.L.C., Westlake, LA (US)

(72) Inventors: Mark R. Moore, Westlake, LA (US); Peter Prados, Lafayette, LA (US)

(73) Assignee: Prep Tech, L.L.C., Westlake, LA (US)

(21) Appl. No.: 17/301,217

(22) Filed: Mar. 29, 2021

Related U.S. Application Data
(60) Provisional application No. 63/001,379, filed on Mar. 29, 2020.
(60) Provisional application No. 62/704,092, filed on Apr. 21, 2020.
(60) Provisional application No. 62/706,393, filed on Aug. 13, 2020.

(51) Int. Cl. A61G 10/00; E04H 15/20

(52) U.S. Cl. CPC A61G 10/005; E04H 2015/206; E04H 2015/201; E04H 15/20

(57) ABSTRACT

An isolette comprising an array of instantly inflatable, prepackaged tubes, flexible sheeting, and a drape, is provided. Access ports allow patient access. A component access panel is provided. The drape includes an optional sealing ring held in position by a strap or medical tape. An alternative embodiment comprising a non-pressurized support frame and a drape subassembly is also provided. The support frame includes arches, cross beams, and support beams that are adhered together. The access ports can include iris diaphragms, covering flaps, integrated gloves, and removable gloves.

### CROSS-REFERENCE TO RELATED APPLICATIONS

This application claims priority benefit from U.S. Provisional Application No. 63/001,379, filed on Mar. 29, 2020, U.S. Provisional Application No. 62/704,092, filed on Apr. 21, 2020 and U.S. Provisional Application No. 62/706,393 filed on Aug. 13, 2020. The patent applications identified above are incorporated here by reference in their entirety to provide continuity of disclosure.

### FIELD OF THE INVENTION

The present invention is related to patient isolation using medical isolettes.

### BACKGROUND OF THE INVENTION

Patient isolation represents one of several measures that can be taken to control the spread of infection and highly contagious diseases. The goal of patient isolation is to contain airborne contagions produced by the patient, or alternatively, to limit airborne contagions to which the patient is exposed.

The U.S. Centers for Disease Control and Prevention (CDC) issues, and periodically revises, recommendations for various levels of patient isolation for disease control. Isolation is typically recommended when a patient is known to have a highly contagious viral or bacterial illness.

Special isolation protocols are used in the management of patients in isolation. Typical isolation protocols include mandating personal protective equipment such as gowns, masks, and gloves and applying physical controls, such as negative pressure rooms, laminar air flow and structural barriers. Negative pressure is used to reduce risk of exposure to airborne contagions produced by the patient.

Patients can produce airborne contagions in any number of circumstances. For example, airborne contagions are typically produced by a patient during intubation. Intubation is required when the patient cannot maintain their airway or cannot breathe without assistance. Intubation requires inserting an endotracheal tube, through the mouth and then into the airway. The tube is then connected to a ventilator. Intubation typically takes place after a patient is anaesthetized. Even so, patient reflex reactions usually cause coughing during the intubation procedure which can result in a significant amount of airborne contagion being released.

The requirement for patient isolation and intubation occurs in many circumstances. For example, patient isolation and intubation can take place in an emergency situation in the field. Emergency isolation in the field is difficult because physical control protocols such as negative pressure rooms and structural barriers are difficult to erect quickly and at low cost. Further exacerbating the problem, intubation is typically prescribed only once a dangerous condition is recognized. Oftentimes, such diagnoses are made in emergencies with extremely limited time to react.

Emergency situations, such as epidemics, also create special problems. For example, epidemics, such as swine flu, MERS-COV and Ebola are considered highly contagious. Such highly contagious diseases certainly require effective negative pressure isolation and many times also require patient intubation, simultaneously. Effective negative pressure containment is critical to control rapid transmission of these diseases. In these situations, it is extremely difficult to protect caregivers during the intubation process, given the current state of the art in isolation barriers.

The prior art has attempted many different methods and structures to solve the problems of simple, inexpensive and portable isolation barriers but all have fallen short.

For example, U.S. Pat. No. 5,832,919 issued to Kano discloses a portable enclosure system which provides a suitable breathing atmosphere within a chamber, by use of positive pressure provided by fans and exhaust ports. However, the chamber does not allow access to the patient to provide medical treatment and fails to provide a negative pressure environment.

U.S. Pat. No. 7,757,689 issued to Chang discloses an inflatable isolation “cabin” for isolation of the entire patient, prior to transport. However, the cabin must be removed to provide medical treatment such as surgery or intubation.

Another example is disclosed in U.S. Pat. No. 4,949,714, to Orr. Orr discloses a medical hood for fitting over the head of a patient. A gas port leads to the interior of the hood for supplying respiratory gas. An outlet connects the interior of the hood and the ambient air for discharge of gas. However, the hood of Orr is rigid and therefore does not provide for a collapsible frame for ease of use and transport.

Another example is U.S. Pat. No. 5,950,625 to Bongiovanni, et al. Bongiovanni discloses an isolation bag for isolating a casualty from a contaminated environment. The bag is fabricated from a transparent biochemically resistive material and includes a self-contained transportable life support system. However, the transportable system, including the bag, is difficult to replicate cheaply or transport easily and is time consuming to assemble and use.

A need exists to provide a device and method to isolate a patient while allowing the patient to be intubated or receive other medical treatment. Further, a need exists for an isolation chamber that may be quickly deployed to protect health care providers from contagions while completing the intubation procedure. Still further, a need exists for an isolette that is inexpensive and which can be easily and quickly mass produced to aid in mass isolation of patients with highly contagious epidemic diseases.

A further need exists for an isolette that may be vacuum packed in a small light weight package which can be easily shipped in large numbers, and quickly assembled and deployed when needed.

A further need exists for an isolette that provides a negative pressure environment to protect health care workers when accessing a patient.

### SUMMARY OF THE INVENTION

A preferred embodiment of an isolette includes a set of interconnected inflatable perimeter tubes that form an instantly inflatable six-sided cube. Thermoplastic sheets are inductively welded or adhered to the perimeter tubes to create perimeter sides. Access ports with removable iris diaphragms and/or integrated gloves are provided in the perimeter sides. A negative pressurization port and a component access panel are provided. The isolette may have a base panel formed of a flexible material adhered to the perimeter tubes. The top of the isolette has a flexible sheet that is inductively welded to the top of one of the perimeter tubes for ease of patient access.

One preferred embodiment includes a patient drape inductively welded or manually adhered to the cube. The patient drape extends outward from the cube and is tucked around the patient's abdomen. The drape end may also have an optional sealing ring made of closed cell foam which is sealed to maintain a pressure barrier around the patient.

In another preferred embodiment, an isolette comprises a base panel, a support subassembly, and a drape subassembly. The support subassembly includes two semi-flexible side support arches. Each side support arch is connected at both ends to a side support beam. A back cross beam, a front cross beam, and a front support beam are connected between the side support arches.

The drape subassembly comprises side panels, a cover and a drape sheet. Both side panels include at least one access port. The side panels can include a vacuum or negative pressure port and a component access panel. The cover sheet may include two access ports. The access ports can include integrated or manually inserted gloves. The cover sheet can include a viewing port. The cover sheet is positioned between and adhered to the two side panels. The drape sheet extends from the top panel and is secured to the patient with a sealing ring.

The drape subassembly is fitted over the support subassembly and adhered to the side support beams and the front support beam. The side support beams and front support beam are further adhered to the base panel.

In a preferred embodiment, the side panels and cover sheet can further include integrated gloves, resealable flaps, sealing caps or iris diaphragms that cover the access ports.

In one preferred embodiment, a component access panel is provided. The component access panel is inductively welded into the side panel and includes a horizontal slit with removable sealed plugs of various sizes. The plugs accommodate various sizes of tubes and electrical leads.

In another preferred embodiment, the component access panel is provided with various connectors for connection to a patient circuit and Luer Lock or other connectors for a CO₂ monitor.

In another preferred embodiment, the access ports can include gloves inductively welded to removable connection fittings which are fixed to the access ports.

In use, the isolette is removed from a folded and/or vacuum packaged storage bag by being inflated with either a manual pump or instantly with a CO₂ cartridge. The isolette is positioned over the patient's head with the patient's head surrounded by the cube. The drape is positioned over the patient's body. The optional sealing ring is secured around the patient. The sealing ring in held in position by a Velcro® type product strap or medical adhesive tape. A source of negative pressure is applied by a suction turbine through a pressurization port. The patient is accessed through side and front ports or via the top flexible sheet. Electrical and gas supply tubes can be inserted into the isolette through the component access panel.

### BRIEF DESCRIPTION OF THE DRAWINGS

In the detailed description of the preferred embodiments presented below, reference is made to the accompanying drawings.

FIG. 1A shows a preferred embodiment of an isolette in a folded and/or vacuum sealed shipping package.

FIG. 1B is an isometric view of a preferred embodiment of an isolette.

FIG. 2 is an exploded isometric view of a preferred embodiment of an isolette.

FIG. 3A is detail view of an alternate preferred embodiment of a side panel.

FIG. 3B is detail view of an alternate preferred embodiment of a side panel.

FIG. 4A is an exploded view of a preferred component access panel.

FIG. 4B is an exploded view of an alternate embodiment of a component access panel.

FIG. 5 is an isometric view of an alternate embodiment of a component access panel.

FIG. 6A is an exploded isometric view of a preferred glove connection.

FIG. 6B is an isometric view of a preferred glove connection.

FIG. 6C is an isometric view of a preferred glove connection.

FIG. 6D is an exploded isometric view of a preferred glove connection.

FIG. 6E is an exploded isometric view of a preferred barrier cap.

FIG. 7 is a side view of a preferred embodiment of an isolette is use.

FIG. 8 is a flowchart of a preferred method of use of an isolette.

FIG. 9 is an isometric view of an alternate preferred embodiment of an isolette.

FIG. 10 is an exploded isometric view of an alternate preferred embodiment of an isolette.

FIG. 11 is a flowchart of a preferred method of use of an isolette.

### DETAILED DESCRIPTION OF THE INVENTION

In the description that follows, like parts are marked throughout the specification and figures with the same numerals, respectively. The figures are not necessarily drawn to scale and may be shown in exaggerated or generalized form.

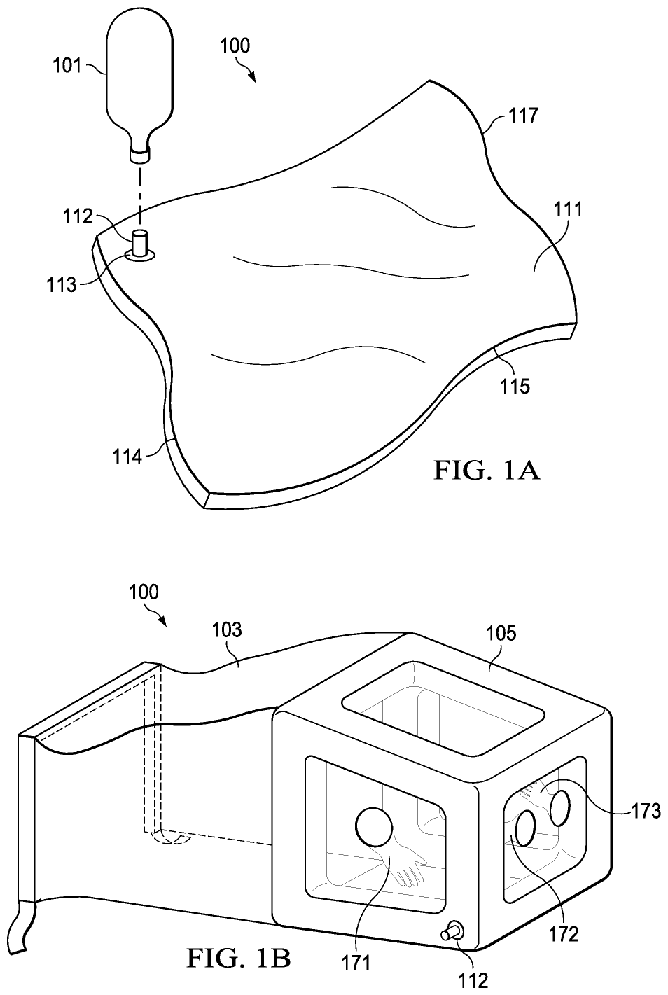

Referring then to FIG. 1A, a pre-packaged isolette will be described. Pre-packaged isolette 100 includes flexible plastic package 111. Inflation port 112 protrudes through package 111 and is ductedly connected to the isolette, as will be further described. Package 111 is evacuated to remove air and potential contagions from contact with the deflated isolette within. The vacuum seal, when used, is important because it reduces the volume of the package and stabilizes the deflated isolette for shipping. Package 111 is further provided with failure lines 114, 115 and 117. The failure lines are reduced cross section tear lines in the plastic sheeting which are designed to rupture when the isolette is inflated. Inflation port 112 is adapted to interface with a CO₂ cartridge, a manual pump, or an electric pumps.

In use, CO₂ cartridge 101 is applied to inflation port 112, thereby inflating the isolette which expands, rupturing failure lines 114, 115 and 117 and expanding outside the package. Once the failure lines are ruptured, package 111 forms a flat surface, joined to the isolette at the inflation port, where it can be easily removed and discarded. After use, package 111 is discarded, along with the (optional) CO₂ cartridge.

Referring then to FIG. 1B, isolette 100 is comprised of drape subassembly 103 and cube subassembly 105. Integrated gloves 171, 172 and 173 are provided to access the interior of the isolette, as will be further described.

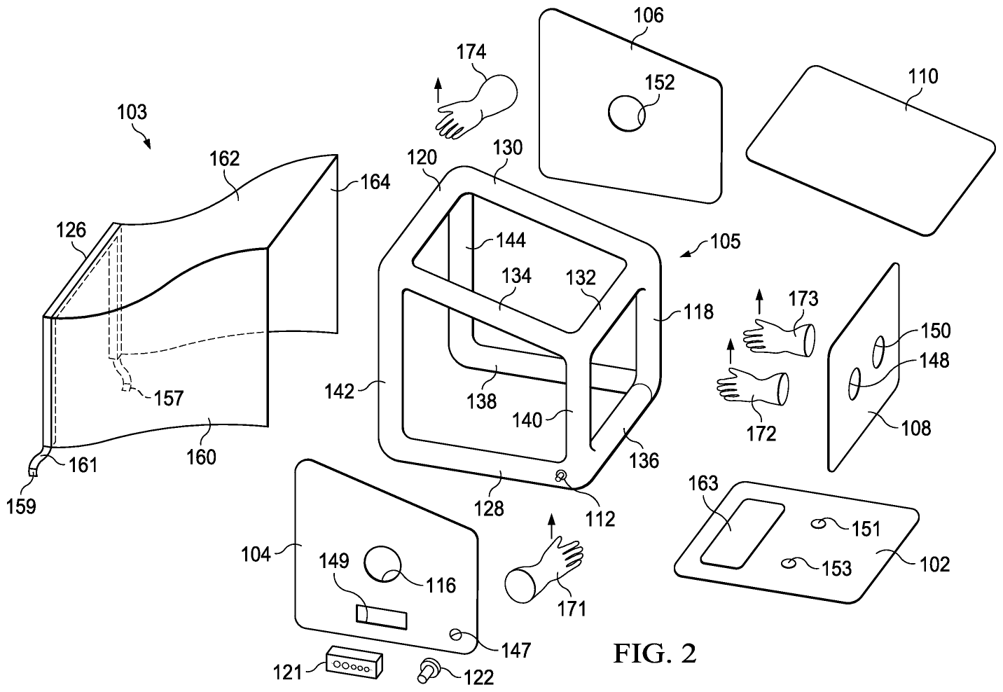

Referring to FIG. 2, isolette 100 will be further described. Cube subassembly 105 forms a generally six-sided flexible cube. The generally six-sided flexible cube further comprises inflatable top support tubes 120, 130, 132, and 134, vertical support tubes 118, 140, 142, and 144, and base support tubes 128, 136, and 138 and base panel 102. The top support tubes, vertical support tubes, and base support tubes are generally cylindrical and hollow and are ductedly connected where they intersect. The top support tubes are generally coplanar and are all interconnected at generally right angles. Likewise, the base support tubes are all generally coplanar and are interconnected at generally right angles. The vertical support tubes are all generally vertical and are connected to the base tubes at generally right angles. Top support tubes 130 and 134 slope downward away from top support tube 120 and toward top support tube 132 at about a 10° angle. The downward slope is important because it aids in viewing the patient from the front of the isolette through the top panel, as will be further described.

In a preferred embodiment, the isolette includes an optional base panel. Base panel 102, if present, is fixed to base support tubes 128, 136, and 138 by a suitable adhesive after the isolette is inflated. Base panel 102 is preferably comprised of corrugated polyethylene sheeting approximately 20 to 60 mils thick. In another preferred embodiment, the base panel further comprises an absorbent paper substrate affixed to its top surface. The base panel may also include sensors 151 for temperature monitoring. Blood oxygen sensor 153 may also be integrated in the base panel. The base panel may also include heating and cooling panel 163 for maintenance of patient temperature.

In a preferred embodiment, top support tubes 120 and 132 and base support tube 136 are about 22 inches in length. Base support tubes 128 and 138 are about 16 inches in length. Top support tubes 134 and 130 are about 16.2 inches in length. Vertical support tubes 142 and 144 are about 18 inches in length. Vertical support tubes 140 and 118 are about 16 inches in length. Vertical support tubes 142 and 144 and top support tube 120 form a three-tube patient entry frame. Base support tubes 128, 136 and 138 form a three-tube base frame. Top support tubes 134, 132 and 130 and vertical support tubes 118 and 140 form a five-tube panel support frame. In a preferred embodiment, each support tube is manufactured from a flexible, transparent, linear, low density polyethylene sheeting, approximately 20 mils thick.

Inflation port 112 is positioned in base support tube 128 and is ductedly connected to the top support tubes, the base support tubes and the vertical support tubes. The inflation port may be positioned in any of the support tubes. Inflation port 112 is preferably attached to collar 113, which protrudes through and is sealed against package 111. In one preferred embodiment, the inflation port can comprise a valve stem adapted to connect with a CO₂ cartridge or a manual pump. In another preferred embodiment, the inflation port comprises a 22 mm universal connection capable of connecting to a standard 22 mm or 15 mm oxygen line.

Side panel 104 is inductively welded to base support tube 128, vertical support tube 142, top support tube 134, and vertical support tube 140. Side panel 104 includes access port 116, component access panel 121, and connector 122, as will be further described.

Integrated glove 171 is fixed to side panel 104 adjacent access port 116, as will be further described. The access port is preferably centered in the side panel. Connector 122 is affixed to side panel 104 adjacent hole 147. Likewise, component access panel 121 is affixed to side panel 104 adjacent hole 149, as will be further described. In a preferred embodiment, connector 122 is adapted to connect to a filtered turbine fan vacuum supply, or alternatively, a source of air pressure.

Side panel 106 is inductively welded to base support tube 138, vertical support tube 144, top support tube 130, and vertical support tube 118. Side panel 106 includes access port 152. The access port is preferably centered in the lower part of the side panel. Integrated glove 174 is inductively welded to the side panel inside access port 152.

Front panel 108 is inductively welded to base support tube 136, vertical support tube 140, top support tube 132, and vertical support tube 118. The front panel comprises access ports 148 and 150. Integrated gloves 172 and 173 are inductively welded to the front panel adjacent access ports 148 and 150, respectively.

In a preferred embodiment, all the gloves are “bi-directional” and can be used with either the right or left hand. The gloves are preferably oversized so that they may be used within a sterile environment. Also, importantly, each of the bi-directional gloves are oriented with the thumb upward (as shown by the directional arrows) with respect to the isolette. The upwards orientation of the thumb is important because it facilitates speed of use with either hand.

Top panel 110 is inductively welded to top support tubes 120, 130, 132 and 134.

Side panels 104 and 106, front panel 108 and top panel 110 are preferably flexible, semi-transparent or transparent polyethylene sheeting between about 8 and 30 mils thick.

Drape subassembly 103 comprises top sheet 162, side sheet 160, and side sheet 164. In another embodiment, the drape subassembly may be formed in a single integrated sheet. The drape subassembly generally forms a three-sided flexible covering adapted to be attached to the patient. Top sheet 162 is inductively welded to top support tube 120. Side sheet 160 is inductively welded to vertical support tube 142. Side sheet 164 is inductively welded to vertical support tube 144. The top sheet and the side sheets are constructed of flexible polyethylene sheeting. In a preferred embodiment, the top sheet and side sheets distally taper thereby reducing excess drape material and making the drape form fitting around the patient.

Internal sealing ring 126 is fixed adjacent side sheet 160, top sheet 162 and side sheet 164 with a suitable adhesive. The sealing ring is preferably constructed of a flexible closed cell butyl rubber and serves to reduce air loss around the patient when the isolette is in use.

Tie down strap 161 is fixed to the exterior surface of sealing ring 126 and extends the perimeter of side sheet 160, top sheet 162 and side sheet 164. Tie down strap 161 preferably includes Velcro® type closures 159 and 157.

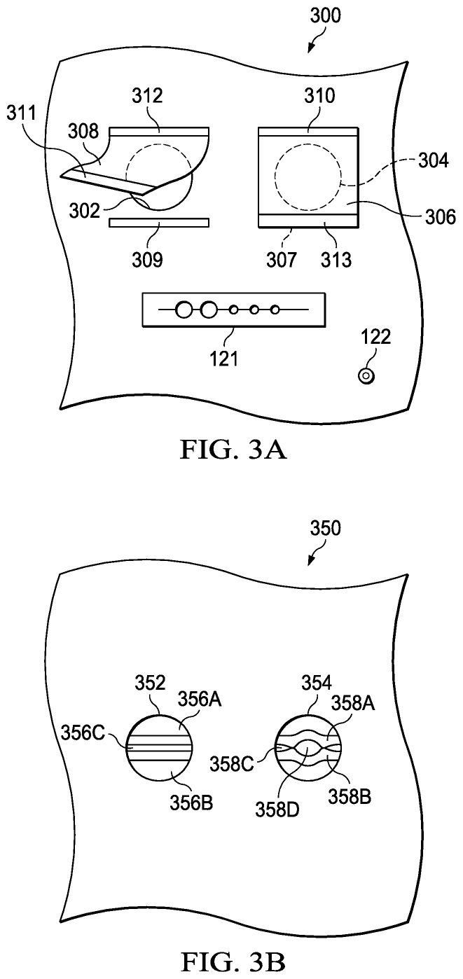

Referring to FIG. 3A, an alternate embodiment of a panel, will be further described. All versions of the panels may optionally be employed in all the various embodiments of the isolette.

Panel 300 further comprises access ports 302 and 304. In this example two (2) access ports are provided in the side panel. However, a single access port in the side panels may be provided. In yet other embodiments, no access ports are provided in the panels, but are created as needed on an ad hoc basis, as will be further described. Flap 308 is fixed to panel 300 adjacent to and covering access port 302. Flap 308 is fixed to the panel by adhesive 312. Flap 308 further comprises closure 311. Panel 300 further include closure 309. In use, closure 311 is removably affixed to closure 309, thereby sealing flap 308 over access port 302.

Likewise, flap 306 is positioned adjacent to and covering access port 304. Flap 306 is fixed to panel 300 via adhesive 310. Closure 307 is fixed to panel 300. Closure 313 is fixed to flap 306. In use, closure 313 is adapted to removably seal against closure 307, thereby sealing flap 306 over access port 304.

Referring then to FIG. 3B, an alternate embodiment of a panel will be further described.

Panel 350 is further comprised of access ports 352 and 354. Access port 352 further comprises iris diaphragms 356a and 356b. Iris diaphragm 356a overlaps iris diaphragm 356b, in region 356c.

Access port 354 is further comprised of iris diaphragm 358a and 358b. Iris diaphragm 358a overlaps iris diaphragm 358b, in region 358c. Iris diaphragms 358a and 358b, are shown in an open position, accommodating opening 358d.

In a preferred embodiment, the iris diaphragms are comprised of butyl rubber sheets or low-density polyethylene (LDPE), approximately 10 mils in thickness. The iris diaphragms are fixed to the exterior of the access port, except for the overlap region, which may be parted by physical pressure, to create a ducted portal in the access port, such as opening 358d.

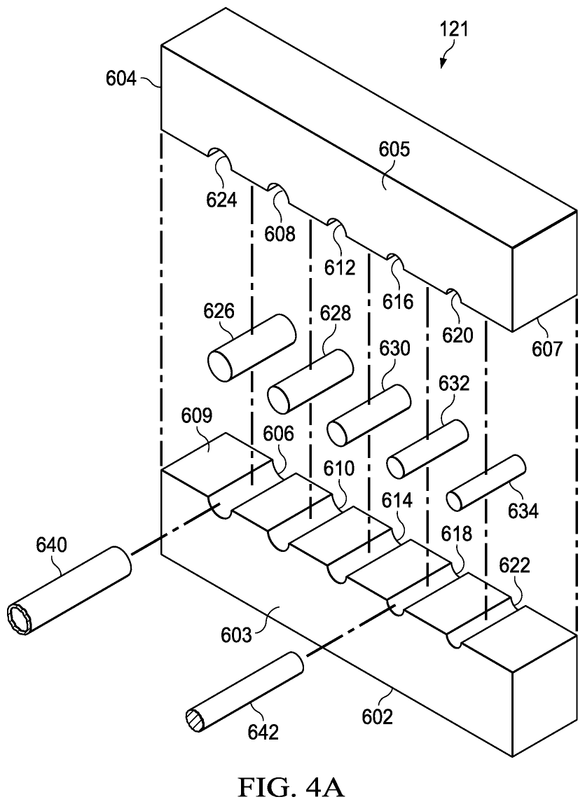

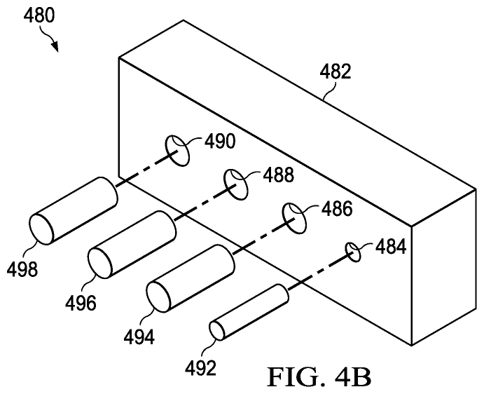

Referring to FIG. 4A, a preferred embodiment of the component access panel will be further described. Component access panel 121 includes top section 604 and bottom section 602. Top section 604 further comprises front face 605 and bottom face 607. Bottom section 602 further comprises front face 603 and top face 609. When assembled, front face 605 and front face 603 are positioned adjacent the inside surface of the side panel and affixed with a suitable medical adhesive. Bottom face 607 is positioned adjacent top face 609.

Semi-cylindrical slots 606, 610, 614, 618, and 622 are formed in the bottom section. Semi-cylindrical slots 624, 608, 612, 616, and 620 are formed in the top section adjacent semi-cylindrical slots 606, 610, 614, 618, and 622, respectively. In general, the slots are all generally parallel and all generally perpendicular to the side panel. When the top and bottom sections are assembled, resealable plug 626 fits within slots 606 and 624. Resealable plug 628 fits within slots 608 and 610. Resealable plug 630 fits within slots 612 and 614. Resealable plug 632 fits within slots 616 and 618. Resealable plug 634 fits within slots 620 and 622. The plugs prevent gas leakage through the access panel. In a preferred embodiment, the slots are adapted to seal against the outside surface of different sized tubes and wires, thereby preventing gas leakage through the access panel by insertion of tubes 640 and wires 642, as will be further described. In a preferred embodiment, component access panel 121 is approximately ¼ inch×1 inch cross-section and approximately 8 inches in length and is comprised of closed cell neoprene rubber foam.

Referring to FIG. 4B, an alternate embodiment of the component access panel will be described.

Access panel 480 is comprised of a single integrated block 482. Integrated block 482 includes through holes 484, 486, 488 and 490. Removable plugs 492, 494, 496 and 498 are positioned in through holes 484, 486, 488 and 490. Preferably, the removable plugs are integrally formed with block 482 and held in place by perforations. The block is preferably comprised of closed cell neoprene rubber foam.

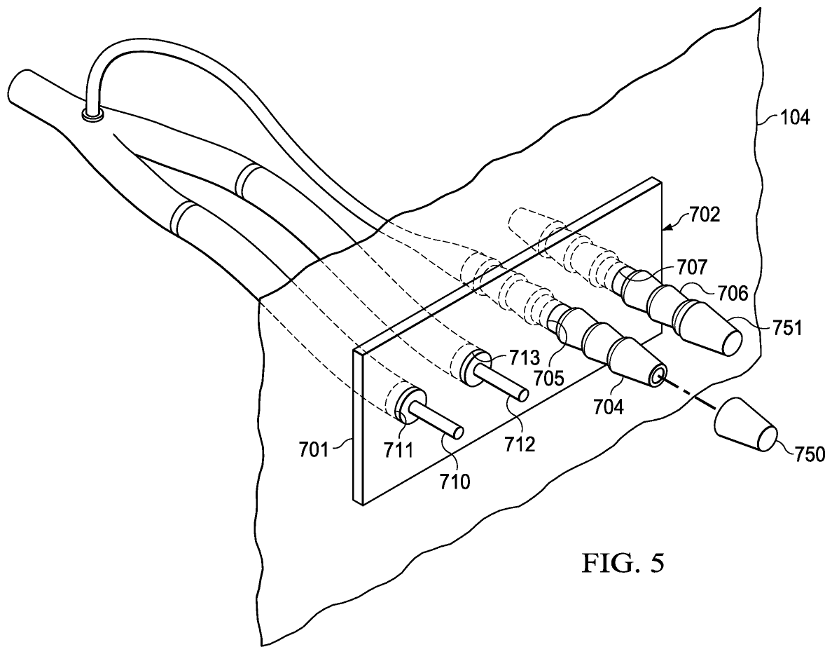

Referring to FIG. 5, an alternate embodiment of the component access panel will be described. Component access panel 702 is generally a semi-rigid plastic connector block supporting several hose connectors. Component access panel 702 further comprises rear surface 701, adhered to side panel 104 with a suitable adhesive.

Component access panel 702 preferably includes a number of double ended connectors forming ducted portals from the exterior of the isolette to its interior. For example, component access panel 702, in this embodiment, includes circuit connector 710, circuit connector 712, circuit connector 704, and circuit connector 706. Circuit connector 710 and circuit connector 712 are adapted to connect to anesthesia lines. Circuit connector 704 and circuit connector 706 are adapted to connect to a source of vacuum. Circuit connector 710 passes through component access panel 702 thru through hole 711. Likewise, circuit connectors 712, 704 and 706 pass through component access panel 702 via through holes 713, 705 and 707, respectively.

In this example, the circuit connectors are adapted to be sealed by caps when not in use, such as cap 750 adapted to mate with circuit connector 704, and cap 751 shown in place on circuit connector 706. In this example, the circuit connectors are either wedge type, slip type or barb type connectors. Other connector types may be used equally well.

In a preferred embodiment, the component access panel is comprised of a semi flexible polyvinyl chloride sheet, approximately 100 mils thick. The circuit connectors may be adhered in the through holes with a suitable medical grade adhesive sealant.

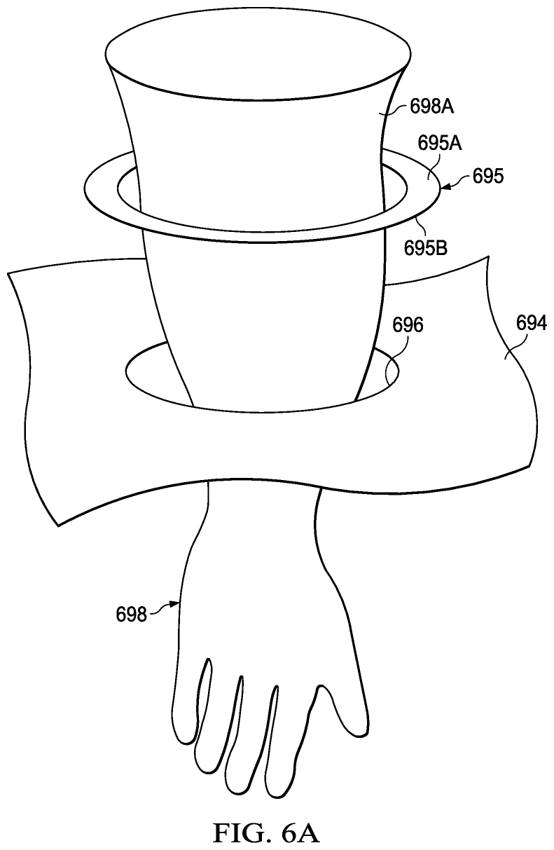

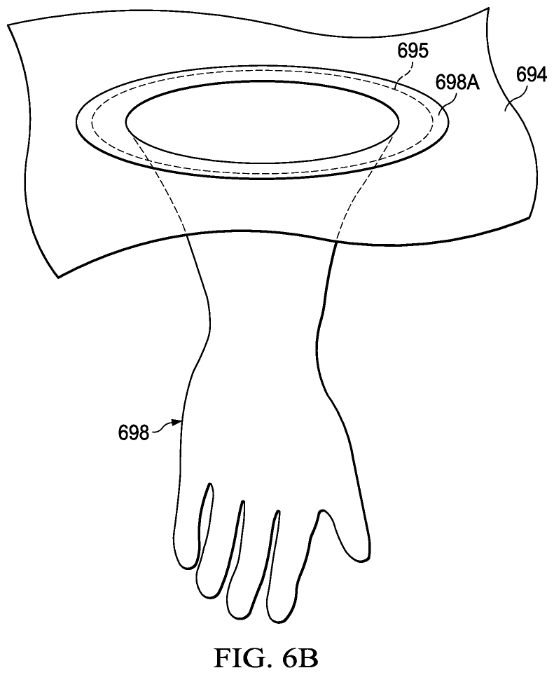

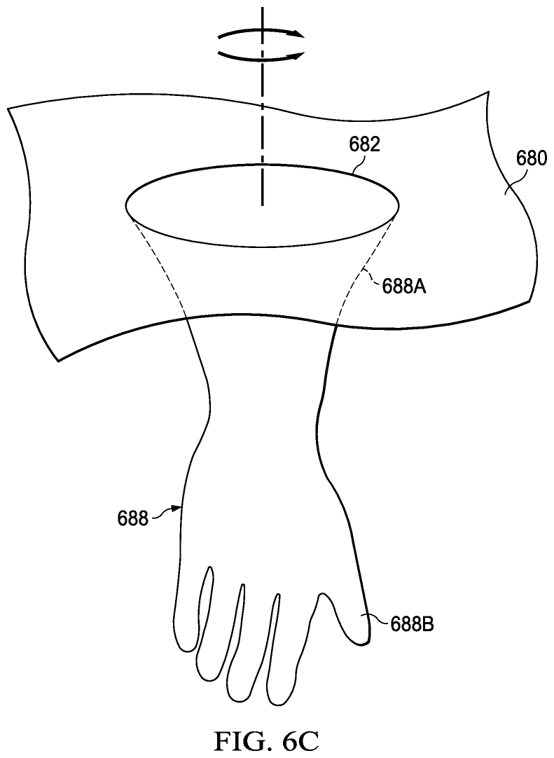

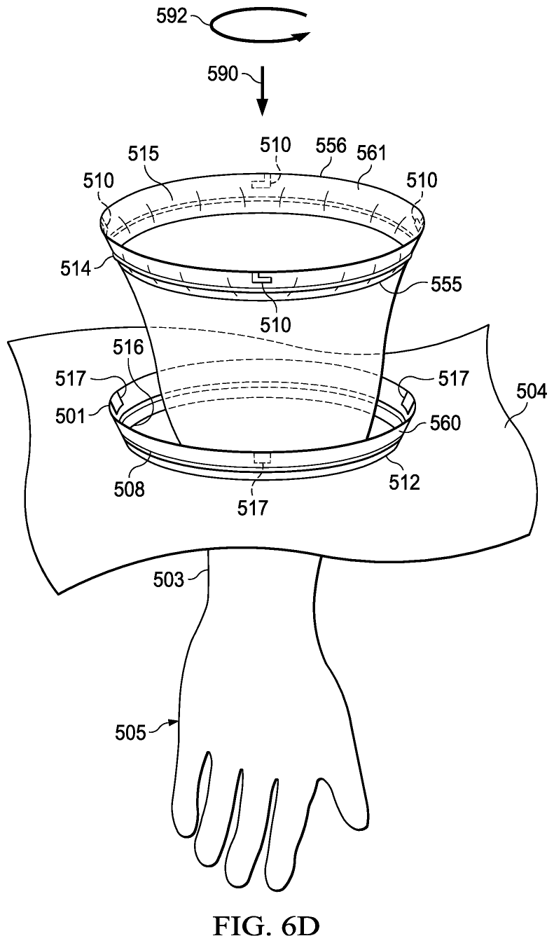

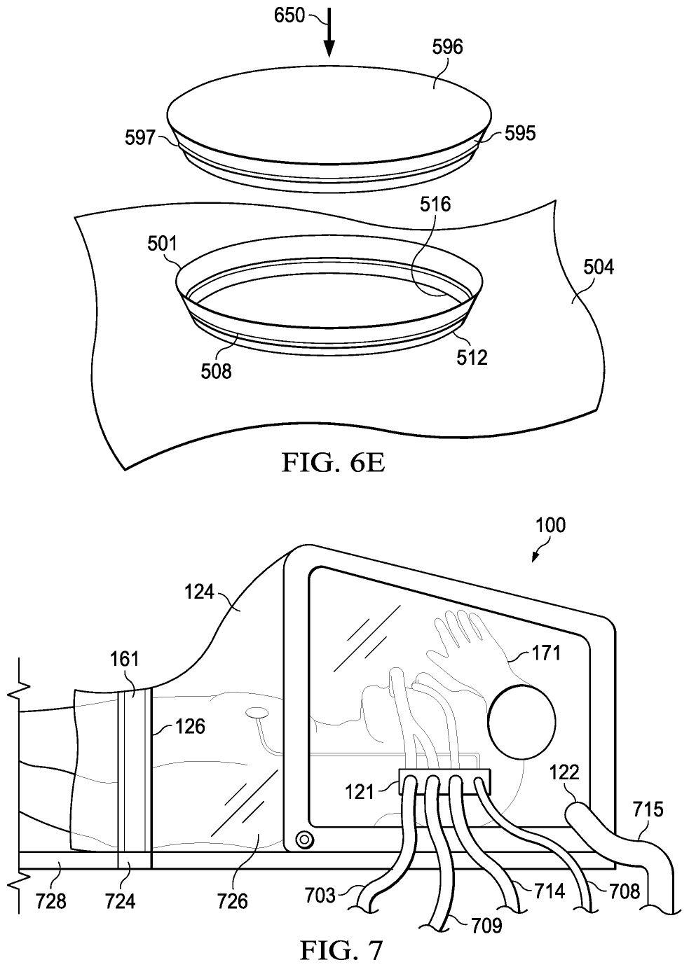

Referring to FIGS. 6A and 6B, an alternate embodiment of an access port will be described.

Panel 694 includes access port 696. Adhesive ring 695 is adapted to circumscribe access port 696. Adhesive ring 695 further comprises adhesive surface 695a and adhesive surface 695b. Glove 698 is adapted to fit within access port 696 and within adhesive ring 695.

Referring then to FIGS. 6A and 6B, when assembled, glove sleeve 698a is fixed to adhesive surface 695a. Panel 694 is fixed to adhesive surface 695b. The connections between glove sleeve 698a and adhesive surface 695a, and adhesive surface 695b and side panel 694, create an airtight seal, thereby allowing access to the glove from the exterior of the isolette without release of contagions within the isolette.

Referring thing to FIG. 6C, an alternate embodiment of an access port will be described. Panel 680 includes access port 682. Panel 680 is fused to glove sleeve 688a of glove 688, around access port 682, thereby allowing access to the glove from the exterior of the isolette. In this embodiment, glove thumb 688b is oriented vertically up with respect to the isolette, when fused to access port 682. The orientation of the glove is important, because a single “non-handed” glove may be used for either the left, or the right, hand. This embodiment is also important, as will be further described, because it can be placed in any position, in a side, or top panel, on an ad-hoc basis.

Referring to FIG. 6D, an alternate embodiment of an access port will be described. Panel 504 includes connection ring 512 sealed adjacent access port 516 along annular interface 501. The connection ring is sealed at the annular interface with suitable medical adhesive. Connection ring 512 is further comprised of frustroconical body 560. Frustroconical body 560 includes annular O-ring channel 508 on its interior surface. Frustroconical body 560 further includes a plurality of bayonet mount pins 517, dispersed at 90° angles on the interior surface of the frustroconical body relative to a central axis of the frustroconical body.

Glove collar 556 is designed to mate with connection ring 512. Glove collar 556 includes frustroconical body 561. Frustroconical body 561 further includes annular O-ring 514 compressed into exterior annular channel 515. The frustroconical body further includes bayonet mount receptors 510.

Glove 505 is attached to glove collar 556 at sleeve 503 and annular interface 555. In preferred embodiments, sleeve 503 is adhered to annual interface 555 with a suitable medical grade adhesive.

In use, glove 505 is advanced through connection ring 512 and into the interior of the isolette. Glove collar 556 advances in direction 590 into connection ring 512 where annular O-ring 514 seats in O-ring channel 508, thereby forming an air-tight seal. Once the O-ring is seated, glove collar 556 is rotated in direction 592 to lock bayonet mount receptors 510 into position adjacent bayonet mount pins 517.

Referring to FIG. 6E, an alternate embodiment of a connection ring, will be further described. Connection ring 512 includes O-ring channel 508 adjacent its interior annular surface. Barrier cap 596 includes frustroconical body 595 and is generally adapted to seal to the connection ring. Frustroconical body 595 includes annular O-ring 597. O-ring 597 is adapted to seat within O-ring channel 508 as barrier cap 596 is advanced into access port 516 in direction 650. Barrier cap 596 is removably fixed in the access point and creates an airtight seal between the exterior of the isolette and the interior of the isolette.

Referring to FIG. 7, isolette 100 is shown in use. Patient 726 is positioned inside the isolette on the base panel. Drape 124 is extended from a position above the isolette downward and around the patient. Integrated glove 171 is positioned inside the interior of the isolette. Internal sealing ring 126 is optionally secured around the patient. Tie down strap 161 is optionally secured to hold the sealing ring in place.

Ventilator tube 703, carbon dioxide exhaust tube 709 and oxygen tube 714 are shown connected through component access panel 121. Likewise, EKG line 708 is shown traversing component access panel 121. Negative pressure hose 715 is shown connected to connector 122 to provide negative pressure to isolette 100.

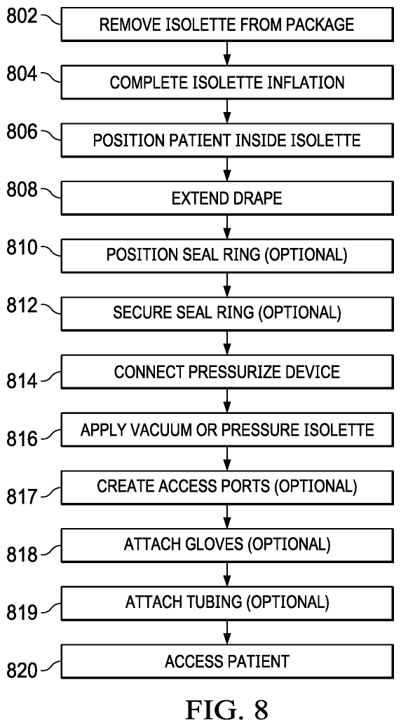

Referring to FIG. 8, a preferred method of use of isolette 100 will be described. At step 802, the isolette is removed from the packaging. In a preferred embodiment, a source of positive pressure is attached to the inflation port which expands outside the packaging. Inflation of the isolette causes the packaging to rupture.

At step 804, the support tubes are fully inflated. In a preferred embodiment, the support tubes are inflated through a single inflation port to between 10 and 40 psi.

At step 806, the patient is positioned inside the isolette. The patient is located in a supine position. The patient's head is positioned on the base panel adjacent the front panel.

At step 808, the drape is extended to cover the patient.

At (optional) step 810, the sealing ring is positioned around the patient. The sealing ring is positioned substantially perpendicular to the patient's torso and arms to create a seal.

At (optional) step 812, the sealing ring is secured around the patient. In a preferred embodiment, the sealing ring is secured by a strap. In other preferred embodiments, the sealing ring is secured by medical adhesive tape or tucked under the sides of the patient.

At step 814, a vacuum system or a pressurization device is connected to the pressurization port. The pressurization device provides negative pressure.

At step 816, the attached suction device is activated and negative pressure is applied within the isolette. In use, the isolette is capable of supporting negative pressure of over 0.01 mmHg.

At step 817, optionally, access ports are created in the panels by cutting an “X” in the panel, at a chosen location, with a bladed instrument. Preferably, the glove sleeves are then fixed to the panel within the incision with a rubber type adhesive, thereby sealing the glove sleeve to the panel.

At step 818, optionally, barrier caps (if present) are removed from the access ports and gloves are attached, as previously described.

At step 819, optionally, plugs are removed from the component access panel and the wires or tubing are positioned in the resulting holes. Tubing may also be connected to the circuit connectors, as previously described. The access panel provides a seal around the wires and tubing to maintain the pressure inside the isolette.

At step 820, the patient is accessed through the access ports of the isolette. In a preferred embodiment the flaps are raised from the side panel and the patient is accessed through the access ports. Once the treatment is complete, the flaps are lowered and secured in place. In another embodiment, barrier caps may be removed to access the patient and replaced when required. In another embodiment, the patient is accessed through integrated gloves.

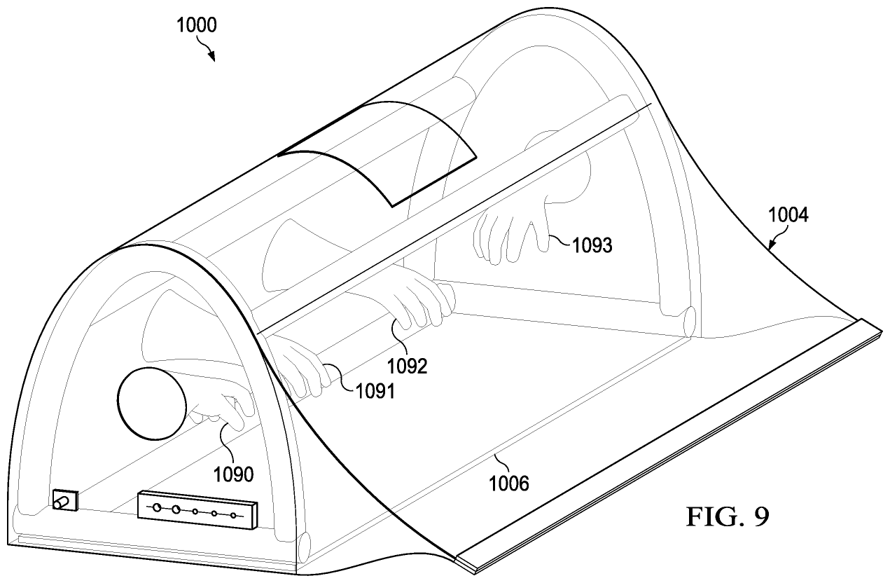

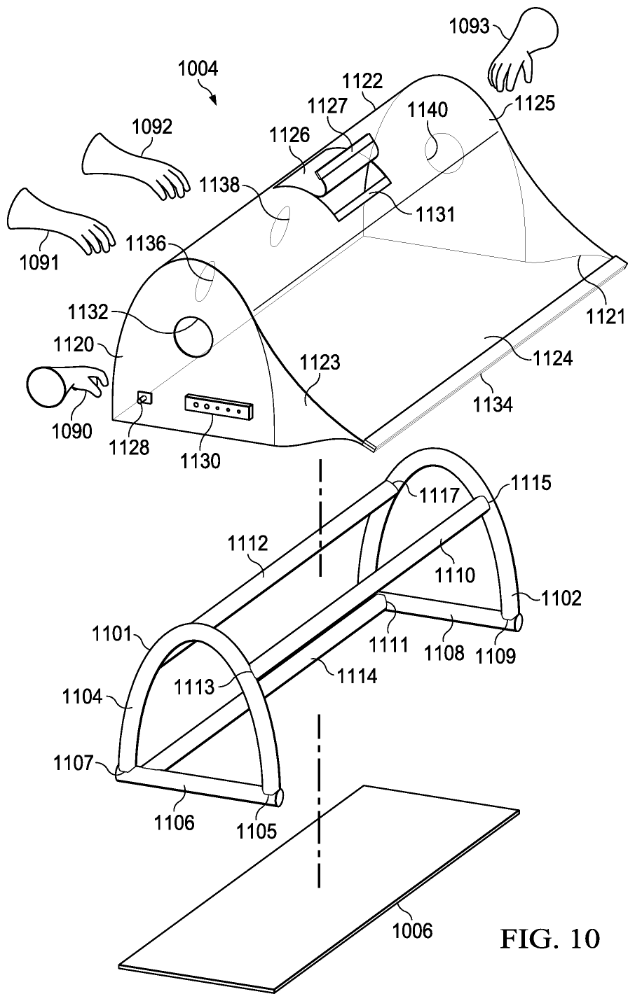

Referring to FIGS. 9 and 10, an alternate embodiment of an isolette will be described.

Isolette 1000 comprises side support arch 1104 and side support arch 1102.

Side support arch 1104 further comprises base beam 1106 joined to side support arch 1104 at joints 1107 and 1105.

Side support arch 1102 further comprises base beam 1108 joined with side support arch 1102 at joints 1111 and 1109.

Side support arch 1104 is connected to side support arch 1102, by front cross brace 1114, front cross brace 1112, and rear cross brace 1110. Front cross brace 1114 is connected to side support arch 1104 and side support arch 1102 at joints 1107 and 1111, respectively. Side support arch 1104 and side support arch 1102 are further connected by front cross brace 1112. Front cross brace 1112 is connected to side support arch 1104 and 1102 at joints 1101 and 1117. Side support arch 1104 is further connected to side support arch 1102 by rear cross brace 1110. Rear cross brace 1110 is connected to side support arch 1104 and side support arch 1102 at joints 1113 and 1115, respectively.

Base panel 1006 is joined along its perimeter edges to base beam 1106, front cross brace 1114 and base beam 1108 by a suitable medical adhesive.

In a preferred embodiment, the front support beam, front cross beam, and back cross beam are approximately the same length of between about 2 feet and about 4 feet.

In a preferred embodiment, all the beams and arches are cylindrical tubes are constructed of closed cell polyethylene foam between about 2 inches and about 4 inches in diameter. All joints are accomplished either through inductive welding, or a suitable medical grade adhesive.

Drape subassembly 1004 includes cover sheet 1122, drape sheet 1124, and side panels 1120, 1123, 1125 and 1121. Cover sheet 1122 is bonded to drape sheet 1124, side panel 1125 and side panel 1120. Side panel 1120 is further bonded to side panel 1123. Side panel 1125 is further bonded to side panel 1121. Side panel 1123 is further bonded to drape sheet 1124. Side panel 1121 is further bonded to drape sheet 1124. In a preferred embodiment, all bonding is accomplished through inductive welding, or a suitable medical graded adhesive. However, the bonding should be airtight.

Cover sheet 1122, preferably includes viewing port 1126. Viewing port 1126 is covered by flap 1127. In a preferred embodiment, flap 1127 is secured to viewing port 1126 by Velcro® type edging 1131.

Side panel 1120 further comprises access port 1132 bounded by integrated glove 1090. Cover sheet 1122 further comprises access port 1136 bounded by integrated glove 1091. Cover sheet 1122 further comprises access port 1138 bounded by integrated glove 1092. Side panel 1125 further comprises access port 1140 bounded by integrated glove 1093. In a preferred embodiment, the access ports and integrated gloves are as those previously described with respect to other embodiments.

Side panel 1120 further comprises component access panel 1130, as previously described. Side panel 1120 further comprises pressurization port 1128, as previously described.

Drape sheet 1124 further comprises sealing ring 1134 adapted to adhere to a patient through an optional medical strap or medical tape, as previously described.

When assembled, side panel 1120 is positioned adjacent side support arch 1104 and base beam 1106 and bonded in place with a suitable medical adhesive. Likewise, side panel 1125 is adhered adjacent side support arch 1102 and base beam 1108 by a suitable medical adhesive. Cover sheet 1122 is adhered to front cross brace 1114, front cross brace 1112, and rear cross brace 1110. Cover sheet 1122 is held in place by front cross brace 1112 and rear cross brace 1110.

The front, top, and side panels, and the drape are made of a flexible transparent or semi-transparent thermoplastic sheeting, preferably between about 8 and 30 mils thick and preferably comprised of a disposable polyethylene sheeting. In a preferred embodiment, the front, top, side panels and the drape are formed as a single sheet. In another preferred embodiment, the front, top, side panels and the drape are separate sheets that are inductively welded or appropriately adhered to each other.

Base panel 1006 is generally rectangular in shape and is constructed of semi-rigid corrugated thermoplastic sheet approximately ⅛ inch thick. In a preferred embodiment, the base panel is corriboard or coroplast.

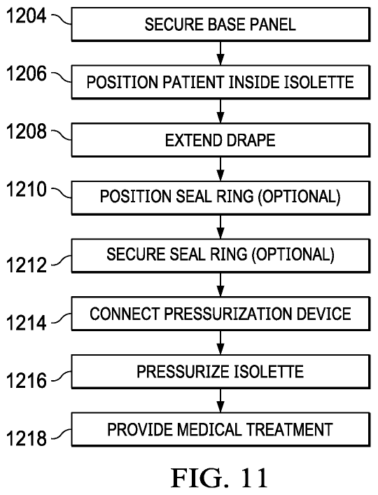

Referring to FIG. 11, a preferred method of use of an isolette as disclosed will be described.

At step 1204, base panel 1006 is secured to a gurney or operating table.

At step 1206, the patient is positioned inside the isolette in a supine position. Preferably, the patient's head is located adjacent front cross brace 1114 and beneath viewing port 1126.

At step 1208, the drape is extended over the patient's body, roughly from the neck or shoulder line to preferably the transpyloric plane.

At step 1210, the optional sealing ring is fitted around the patient's arms and torso.

At step 1212, the optional sealing ring is secured in position against the patient's body. In a preferred embodiment, the optional sealing ring is held in position with a strap positioned over the optional sealing ring and attached to the bed, table, or gurney. In another preferred embodiment, the optional sealing ring is held in position with medical adhesive tape.

At step 1214, the pressurization device is connected to the isolette through the tubing portal.

At step 1216, pressurization is applied to the isolette. In a preferred embodiment, the isolette is capable of supporting negative pressure greater than 0.01 mmHg. In the unusual situation where a positive internal pressure required, the isolette will support it. In this case, at this step, a positive pressure is applied.

At step 1218, medical treatment is provided to the patient through use of the access ports and component access panel. The preferred methods of providing medical treatment have been previously discussed.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

1. A medical isolette comprising:
an inflatable three-tube base frame;
an inflatable three-tube entry frame, ductedly connected to the three-tube inflatable base frame;
an inflatable five-tube panel support frame, ductedly connected to the inflatable three-tube base frame and the inflatable three-tube entry frame;
a flexible top panel sheet, sealed between the inflatable three-tube entry frame and the inflatable five-tube panel support frame;
a first flexible side panel sheet, sealed in the inflatable five-tube panel support frame;
a second flexible side panel sheet, sealed between the inflatable three-tube base frame, the inflatable three-tube entry frame and the inflatable five-tube panel support frame;
a third flexible side panel sheet sealed between the three-tube base frame, the inflatable three-tube entry frame and the inflatable five-tube panel support frame;
a drape assembly, sealed to and extending from the inflatable three-tube entry frame;
an inflation intake, ductedly attached to one of the group of the inflatable three-tube base frame, the inflatable three-tube entry frame, and the inflatable five-tube panel support frame;
a pressure intake, ductedly attached to one of the group of the first flexible side panel sheet, the second flexible side panel sheet, and the third flexible side panel sheet; and,
wherein application of a pressure to the pressure intake creates one of the group of a vacuum and a positive pressure to an interior of the medical isolette.

2. The medical isolette of claim 1 further comprising:
an access port, formed in one of the group of the first flexible side panel sheet, the second flexible side panel sheet and the third flexible side panel sheet.

3. The medical isolette of claim 2 further comprising:
a cover flap, fixed adjacent the access port; and,
a closure means, adjacent the cover flap, for sealing the cover flap against the access port.

4. The medical isolette of claim 2 wherein the access port further comprises:
a semi-rigid connection ring fixed in the access port;
a semi-rigid glove collar, removably fitted in the semi-rigid connection ring; and,
a sealed glove, sealed to the semi-rigid glove collar, and extending into an interior of the medical isolette.

5. The medical isolette of claim 2 wherein the access port further comprises:
a semi-rigid connection ring fixed in the access port; and,
a barrier cap, removably positioned in the semi-rigid connection ring.

6. The medical isolette of claim 2 further comprising:
an iris diaphragm, sealed within the access port.

7. The medical isolette of claim 2 further comprising:
an adhesive ring, positioned adjacent the access port;
a glove, having a glove sleeve; and,
wherein the glove sleeve is sealed to the adhesive ring.

8. The medical isolette of claim 2 further comprising:
a glove, having a glove sleeve and a thumb; and,
wherein the glove sleeve is integrated within the access port.

9. The medical isolette of claim 8 wherein the thumb is oriented upward relative to the medical isolette.

10. The medical isolette of claim 1 further comprising:
a component access panel, fixed in one of the group of a flexible top panel sheet, a first flexible side panel sheet, a second flexible side panel sheet and a third flexible side panel sheet; and,
wherein a set of supply tubes may access the isolette, through the component access panel, without loss of an appreciable internal pressure level.

11. The medical isolette of claim 10 wherein the component access panel further comprises:
a semi-rigid connector block; and,
a set of double-ended connectors, ductedly positioned through the semi-rigid connector block.

12. The medical isolette of claim 10 wherein the component access panel further comprises:
a set of flexible seal portals; and,
a set of removable plugs in the set of flexible set of seal portals.

13. The medical isolette of claim 1 wherein the drape assembly further comprises:
a distal edge; and,
a compressible seal, sealed to the distal edge.

14. The medical isolette of claim 13 further comprising:
a strap means, adjacent the compressible seal, for securing the drape assembly.

15. The medical isolette of claim 1 further comprising:
a vacuum sealed package, surrounding the inflatable three-tube base frame, the inflatable three-tube entry frame, the inflatable five-tube base frame, the first flexible side panel sheet, the second flexible side panel sheet, the third flexible side panel sheet and the drape assembly; and,
wherein the inflation intake extends outside the vacuum sealed package.

16. The medical isolette of claim 15 wherein the vacuum sealed package further comprises:
a predetermined failure line; and,
wherein the predetermined failure line ruptures when a positive pressure is applied to the inflation intake.

17. The medical isolette of claim 15 further comprising:
a compressed gas source connected to the inflation intake.

18. The medical isolette of claim 17 wherein the compressed gas source is a compressed gas cylinder.

19. The medical isolette of claim 1 further comprising:
a semi-rigid base panel sealed to the inflatable three-tube base frame.

20. The medical isolette of claim 19 wherein the semi-rigid base panel further comprises:
one of an electronic patient sensor and patient temperature maintenance panel.

21. A medical isolette comprising:
a three-member base frame;
a first arch support, fixed to the three-member base frame;
a second arch support, fixed to the three-member base frame;
a first cross-member, fixed to the first arch support and the second arch support;
a second cross-member fixed to the first arch support and the second arch support;
a flexible cover, fixed to the three-member base frame, and supported by the first arch support, the second arch support, the first cross-member and the second cross-member; and,
a drape, sealed to the flexible cover, adjacent the first cross-member, the first arch support and the second arch support.

22. The medical isolette of claim 21 further comprising:
a semi-rigid base panel, fixed to the three-member base frame, opposite the flexible cover.

23. The medical isolette of claim 21 wherein the flexible cover further comprises:
a resealable viewing port, between the first arch support and the second arch support.

24. The medical isolette of claim 21 wherein the drape further comprises:
a distal edge; and,
a compressible seal, adjacent to the distal edge.

25. The medical isolette of claim 24 wherein the drape further comprises:
a securing strap, adjacent the compressible seal.

26. The medical isolette of claim 21 further comprising:
a first front access port, in the flexible cover, between the first arch support and the second arch support.

27. The medical isolette of claim 26 further comprising:
a second front access port, adjacent the first front access port, between the first arch support and the second arch support.

28. The medical isolette of claim 27 further comprising:
a first bi-directional glove, sealed in the first front access port; and,
a second bi-direction glove, sealed in the second front access port.

29. The medical isolette of claim 28 wherein:
the first bi-directional glove has a first thumb sheath;
the second bi-directional glove has a second thumb sheath; and,
the first thumb sheath and the second thumb sheath are oriented upwards with respect to the medical isolette.

30. The medical isolette of claim 21 further comprising:
a first side access port, in the flexible cover, centrally located under the first arch support.

31. The medical isolette of claim 30 further comprising:
a second side access port, in the flexible cover, centrally located under the second arch support.

32. The medical isolette of claim 21 further comprising:
a resealable access panel, ductedly fixed in the flexible cover.

33. The medical isolette of claim 21 further comprising:
a pressure connector, ductedly connected to the flexible cover; and,
wherein one of a positive pressure and a vacuum is applied to the medical isolette through the pressure connector.

34. A method of use of a medical isolette comprising:
providing an inflatable three-tube base frame;
providing an inflatable three-tube entry frame, ductedly connected to the three-tube inflatable base frame;
providing an inflatable five-tube panel support frame, ductedly connected to the inflatable three-tube base frame and the inflatable three-tube entry frame;
providing a flexible top panel sheet, sealed between the inflatable three-tube entry frame and the inflatable five-tube panel support frame;
providing a first flexible side panel sheet, sealed in the inflatable five-tube panel support frame;
providing a second flexible side panel sheet, sealed between the inflatable three-tube base frame, the inflatable three-tube entry frame and the inflatable five-tube panel support frame;
providing a third flexible side panel sheet sealed between the three-tube base frame, the inflatable three-tube entry frame and the inflatable five-tube panel support frame;
providing a drape assembly, sealed to and extending from the inflatable three-tube entry frame;
providing an inflation connector, ductedly attached to one of the group of the inflatable three-tube base frame, the inflatable three-tube entry frame, and the inflatable five-tube panel support frame;
providing a pressure connector, ductedly attached to one of the group of the first flexible side panel sheet, the second flexible side panel sheet, and the third flexible side panel sheet;
inflate the medical isolette by applying a compressed gas to the inflation connector;
positioning the medical isolette;
extending the drape;
securing the drape; and,
applying one of a gas pressure and a vacuum to the pressure connector.

35. The method of claim 34 further comprising:
providing an access port, ductedly connected to the medical isolette; and,
sealing a glove sleeve to the access port.

36. The method of claim 35 wherein the step of sealing further comprises:
cutting a hole in one of the group of the first flexible side panel sheet, the second flexible side panel sheet and the third flexible side panel sheet; and,
ductedly connecting the glove sleeve within the hole.

37. The method of claim 34 further comprising:
providing a tear away package surrounding the medical isolette;
evacuating the tear away package; and,
wherein the tear away package ruptures when the compressed gas is applied to the inflation connector.

38. A method of use of a medical isolette comprising:
providing a three-member base frame;
providing a first arch support, fixed to the three-member base frame;
providing a second arch support, fixed to the three-member base frame;
providing a first cross-member, fixed to the first arched support and the second arched support;
providing a second cross-member fixed to the first arched support and the second arched support;
providing a flexible cover, fixed to the three-member base frame, and supported by the first arch support, the second arch support, the first cross-member and the second cross-member;
providing a drape, sealed to the flexible cover, adjacent the first arch support and the second arch support;
providing a pressure connector in the flexible cover;
positioning the medical isolette;
extending the drape;
securing the drape; and,
applying one of a gas pressure and a vacuum to the pressure connector.

39. The method of claim 38 further comprising:
providing an access port, ductedly connected to the medical isolette; and,
sealing a glove sleeve to the access port.

40. The method of claim 38 wherein the step of securing further comprises:
cutting a hole in the flexible cover; and,
ductedly connecting the glove sleeve within the hole.
